(19) United States
(12) Patent Application Publication
(10) Pub. No.: US 2012/0075632 A1
(43) Pub. Date: Mar. 29, 2012

(54) APPARATUS AND METHOD FOR MEASURING SO3 AND H2SO4 CONCENTRATIONS IN GASES

(75) Inventors: Jörn BAASNER, Uberlingen (DE); Heimo BRETON, Uhldingen-Muhlhofen (DE); Sonja SCHULER, Meersburg (DE)

(73) Assignee: SICK MAIHAK GMBH AG, Waldkirch (DE)

(21) Appl. No.: 13/247,631

(22) Filed: Sep. 28, 2011

(30) Foreign Application Priority Data
Sep. 29, 2010 (EP) 10181729.4

(51) Int. Cl. G01N 21/59

(52) U.S. Cl. 356/437

(57) ABSTRACT

The invention relates to an apparatus for the continuous measurement of SO₃ and/or H₂SO₄ concentrations in gases using a photometer having a light source, a cuvette, a receiver, an optical filter unit having at least one optical filter which is selected such that it lets a measurement wavelength pass through which is selected such that it is absorbed as much as possible by SO₃ and/or H₂SO₄ and is absorbed as little as possible by the other components of the gas and the photometer is calibrated with SO₃ and H₂SO₄ gases of known concentrations and having an evaluation unit which includes a memory unit, in which already measured transverse sensitivities at the measurement wavelengths are stored and the evaluation unit can determine a concentration value for SO₃ and/or H₂SO₄ continuously from the photo signals and the stored transverse sensitivities.

The invention relates to an apparatus and to a method for measuring SO₃ and/or H₂SO₄ concentrations in gases.

NOₓ emissions in combustion gases, for example, in coal power stations or other firing plants are limited very strongly due to legal requirements, so that the so-called selected catalytic reduction (SCR) technology must frequently be used. A consequence thereof is the oxidation of SO₂ to SO₃ in the combustion gas. An increased SO₃ emission, however, has significant disadvantages, such as for example, an increased tendency to a formation of ammonium bisulphate in the air heater, to corrosion problems of surfaces already at temperatures below the acid melt point and to increased air haze and of plume discharge by acid aerosols. Frequently additives are injected into the exhaust gas to control the amount of SO₃. However, the injection rate must be controlled and depends on the concentrations of SO₃ and of the H₂SO₄ formed. At present no method and no apparatus is known by means of which the SO₃ and/or the H₂SO₄ concentrations are continuously measurable. Current measurements take place manually or non-continuously by means of FTIR spectroscopy. The possibilities of a continuous SO₃ measurement would mean a large saving of cost with a simultaneous minimal use of the additives for the control of the SO₃ emissions. Even if additives are not used, a more precise and continuous SO₃ measurement could have the purpose of serving to monitor the SO₃ content, to recognize increases in the SO₃ content on changes in the fuel composition or changes of the SCR operation, so that corresponding measures of correction can be taken. A continuous SO₃ monitoring would also aid the reduction of the content of SO₃ in the exhaust gas of power stations, which combust sulfur-containing coal.

For this reason it is the object of the present invention to provide an improved apparatus and method by means of which a continuous measurement of SO₃ and H₂SO₄ is economically possible.

This object is satisfied by an apparatus having the features of claim 1 and by a method having the features of claim 5.

The apparatus in accordance with the invention for the continuous measurement of SO₃ and/or H₂SO₄ concentrations in gases includes a photometer having a light source, a cuvette, a receiver, an optical filter unit having at least one optical filter which is selected such that it lets a measurement wavelength pass through which is selected such that it is absorbed as much as possible by SO₃ and/or H₂SO₄ and is absorbed by the other components of the gases as little as possible. The photometer was calibrated with gases of SO₃ and H₂SO₄ of known concentration. The apparatus further includes an evaluation unit which includes a memory unit, in which already measured transverse sensitivities at the measurement wavelength are stored in tables. The evaluation unit can continuously determine a concentration value for SO₃ and/or H₂SO₄ from the photo signals and stored the transverse sensitivities.

It is possible for the first time to provide an apparatus and a method by means of which the SO₃ and H₂SO₄ can be continuously measured with the invention. In this respect it has been found that it is possible with a simple photometer if a suitable measurement wavelength is selected and a corresponding filter is provided, wherein in particular all transverse sensitivities are considered. The transverse sensitivities must be determined in advance and are then retrievable from a memory unit, in which they are stored as tables. Thereby the SO₃ and/or the H₂SO₄ concentrations can be determined under consideration of the transverse sensitivities from the measured photo current at the measurement wavelength. In this respect a continuous determination means that either the photo current is permanently measured at the measurement wavelength or, however, also other gas components are also determined cyclically by changing the filter, for example, by means of the filter wheel, and their concentrations are determined. Typically such a cycle can be carried out several times per minute, so that each component is “quasi-continuously” determined.

The initially named disadvantages can be avoided by the possibility of measuring SO₃ and H₂SO₄ continuously.

A very essential aspect of the invention is that the apparatus was calibrated prior to its use with SO₃ and H₂SO₄ gases at known concentrations. This is not a natural measure, since SO₃ and H₂SO₄ spectra are only incompletely available in literature. This is also due to the fact that SO₃ immediately reacts to H₂SO₄ in the presence of water and H₂SO₄ itself is extremely aggressive.

For nearly all combustion gases it has been found that a wavelength which lies between 7050 and 7250 nm is suitable as a measurement wavelength for SO₃ and a wavelength which lies between 10,800 and 12,200 nm is suitable for H₂SO₄. In these wavelength regions, such an absorption is present which delivers good results on consideration of the transverse sensitivities.

In an embodiment of the invention the photometer has an optical alignment filter which generates a constant known absorption at the measurement wavelengths. The alignment filter primarily serves to detect drifts, such as for example, temperature drifts and to provide corresponding correction factors, so that the measurement result is finally independent from such drifts. The re-alignment and drift monitoring is carried out in certain time intervals by an alignment measurement preferably automatically.

The method in accordance with the invention for continuous measurement of SO₃ and/or H₂SO₄ concentrations in gases includes the steps of:
generating an SO₃ and/or an H₂SO₄ absorption spectrum;
selecting a measurement wavelength for SO₃ and/or H₂SO₄;
providing an optical filter for the measurement wavelength;
calibrating a photometer at the measurement wavelength;
detecting transverse sensitivities at the measurement wavelength with regard to all other components present in the gas to be measured;
storing the transverse sensitivities in a memory unit of an evaluation unit for the photometer;
measuring the absorption of gas with the photometer at the measurement wavelength;
correcting the measured absorption values with the stored transverse sensitivity;
and determining the concentration of SO₃ and/or H₂SO₄ from the corrected absorption values.

In the following the invention will be explained in detail by means of an embodiment with reference to the drawing. In the drawing there is shown:

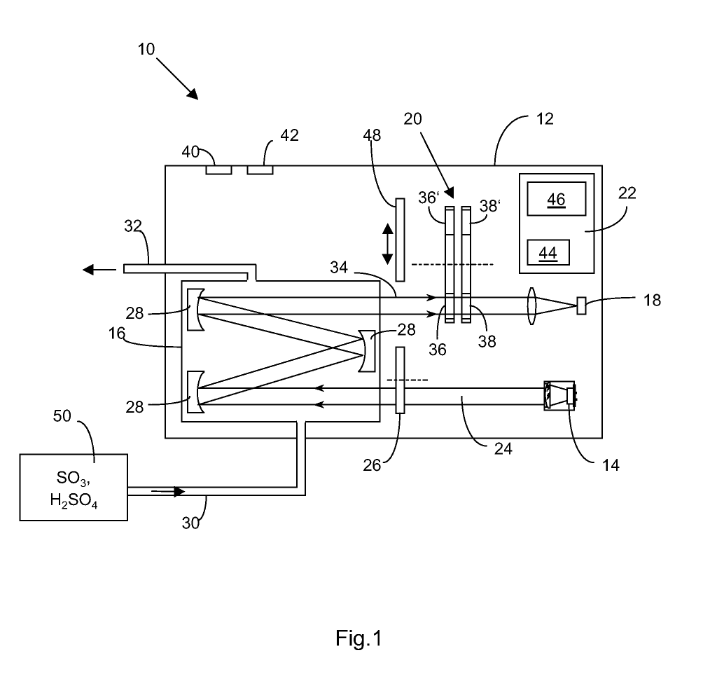

FIG. 1 an apparatus in accordance with the invention;

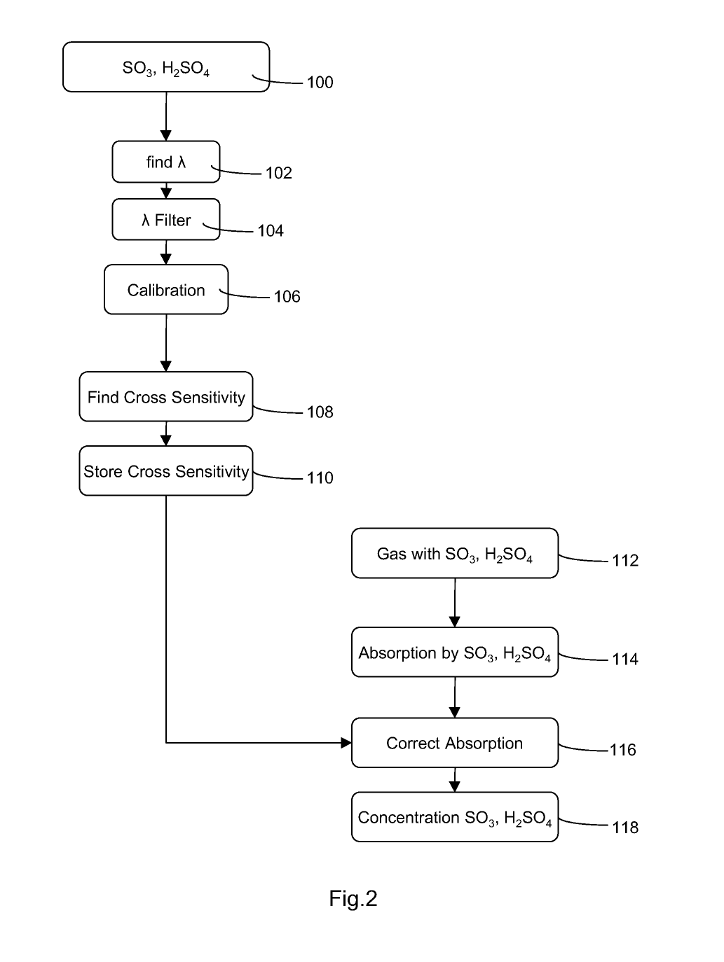

FIG. 2 essential steps of the method in accordance with the invention.

An apparatus in accordance with the invention is configured as a photometer 10. The photometer 10 includes a light source 14, a cuvette 16, also known as a cell 16, a light receiver 18, an optical filter unit 20 and an evaluating unit 22 in a housing 12.

The photometer 10 is designed as a single beam infrared filter photometer which allows the simultaneous use of bifrequence and gas filter correlation methods. The light source 14 transmits infrared light 24 and is characterized by a high release of energy and a long lifetime. The transmitted light 24 passes a chopper wheel 26 and enters into the cuvette 16.

The cuvette 16 has a large optical path length and a small volume. The optical path length of the cuvette 16 is fixedly set via mirrors 28 milled into the end faces and depending on the design amounts to 3 or to 6 m. The cuvette 16 is optimized with respect to a small volume and a fast gas exchange. The gas to be measured is supplied to the cuvette 16 via a gas inlet 30 and is removable via a gas outlet 32. It can be set to temperatures of up to 220° C. A protective filter is present in the gas inlet. Optionally a non-illustrated through-flow meter for flow monitoring of the measurement gases can be integrated. All parts touched by the measurement gas can be heated to a high degree, to prevent a falling below the melting point.

The light 34 exiting the cuvette 16 passes the filter unit 20 with its filters 36 and 38 which are interference filter and/or gas filters and the light is incident on the light receiver 18 which is preferably designed as a pyroelectric detector. The filter unit 20 includes, amongst other things, an IR filter having a filter wavelength which lies between 7050 nm and 7250 nm i.e. whose permeability lies at a certain half-life width of a certain filter wavelength in this wavelength region, as well as a further IR filter having a filter wavelength between 10,800 and 12,200 nm.

The detector 18 is connected to the evaluation unit 22 in which the signal of the detector 18 is evaluated and the concentration of SO₃ and/or of H₂SO₄ in the measurement gas is determined. For this purpose the evaluation unit includes a control computer, a memory unit 44 and a user interface 46 having a keyboard and a display. The measurement values can be output to the outside via interfaces 40 and 42.

Furthermore, an optical post alignment filter 48 is provided which can be inserted into the optical path, when required, for post-adjustment and drift monitoring. The optional use of the post alignment filter 48 also permits the fast control of the set sensitivity.

The method in accordance with the invention is carried out according to the following steps:

Initially SO₃ and H₂SO₄ are generated in a suitable apparatus 50 in different concentrations in the gas phase in the step 100. This is connected with particular difficulties, as SO₃ is not stable and for this reason cannot be purchased and H₂SO₄ is highly aggressive and highly corrosive. However, a precise method for the manufacture of the substances is not the subject matter of this invention and for this reason shall not be explained any further. Finally, absorption spectras are recorded by means of these substances using an FTIR spectrometer.

It is thereby possible to select a measurement wavelength for SO₃ and/or H₂SO₄ in the step 102 in which the absorption measurements should be carried out. A wavelength is selected which is absorbed as much as possible by SO₃ and/or by H₂SO₄ and is absorbed as little as possible by the other components of the measurement gas, to obtain as small transverse sensitivities as possible. For almost all combustion gases it has been found that a measurement wavelength in the region of 7050 and 7250 nm is suitable for SO₃ and a wavelength between 10,800 and 12,200 nm is suitable for H₂SO₄. Then optical filters are provided for these measurement wavelengths in the step 104, which filters must possibly be specifically manufactured.

Finally, a photometer is calibrated at these wavelengths in step 106. Then the transverse sensitivities are determined at the measurement wavelength with regard to all gas components present in the gas to be measured by the photometer 10 in step 108 and are stored in the memory unit 44 in the same form of tables (in step 110).

Finally, the absorption of the measurement gas with the photometer at the measurement wavelength is measured in step 112 and in step 114, to thereby determine the absorption by SO₃ and/or by H₂SO₄ and from this to determine the concentration in step 118. However, for the correct determination of the concentration the measured absorption must be corrected by means of the transverse sensitivities stored in the memory unit in step 116 which takes place in the evaluation unit.

From this the values for the concentration of the SO₃ and H₂SO₄ result from the corrected absorption values at the end in step 118.

So that no condensation arises on the conducting through of the measurement gas through the cuvette, one has to ensure a continuous heating to approximately 200° C. of all components (measurement gas extraction sensor, measurement gas filter, measurement gas line, measurement gas pump, measurement cell). Cold bridges must be avoided.

For the routine checking of the running photometer the alignment filter can be introduced into the optical beam path. Thereby alignment errors and drifts, such as temperature drifts, can be recognized and can be considered during the evaluation.

Beside the filters 36 and 38 the filter unit 20 also has other filters 36′ and 38′, which are also interference filters and/or gas filters each, however, have a different filter wavelength. And indeed wavelengths at which the other gas components of the measurement gas to be measured are absorbed and can be measured. Thereby also concentrations of, for example, H₂O, NO, SO₂, CO₂ and CH₄ can be determined. For this purpose filter wheels of the filter unit 20 are normally rotated, so that the measurement of a gas component only takes a millisecond, so that generally all desired gas components, including SO₃ and H₂SO₄ (are quasi) continuously measured.

1. An apparatus for the continuous measurement of SO₃ and/or H₂SO₄ concentrations in gases using a photometer having a light source, a cuvette, a receiver, an optical filter unit having at least one optical filter which is selected such that it lets a measurement wavelength pass through which is selected such that it is absorbed as much as possible by SO₃ and/or H₂SO₄ and is absorbed as little as possible by the other components of the gas and the photometer is calibrated with SO₃ and H₂SO₄ gases of known concentrations and having an evaluation unit which includes a memory unit, in which already measured transverse sensitivities at the measurement wavelengths are stored and the evaluation unit can determine a concentration value for SO₃ and/or H₂SO₄ continuously from the photo signals and the stored transverse sensitivities.

2. An apparatus in accordance with claim 1, wherein the measurement wavelength for SO₃ lies between 7050 and 7250 nm and for H₂SO₄ between 10,800 and 12,200 nm.

3. An apparatus in accordance with claim 1, wherein an optical alignment filter is provided which generates a constant known absorption at the measurement wavelength.

4. A method for the continuous measurement of SO₃ and/or H₂SO₄ concentrations in gases having the steps of:
generating an SO₃ and/or an H₂SO₄ absorption spectrum;
selecting a measurement wavelength for SO₃ and/or H₂SO₄;
providing an optical filter for the measurement wavelength;
calibrating a photometer at the measurement wavelength;
detecting transverse sensitivities at the measurement wavelength with regard to all other components present in the gas to be measured;
storing the transverse sensitivities in a memory unit of an evaluation unit for the photometer;
measuring the absorption of the gas with the photometer at the measurement wavelength;
correcting the measured absorption values with the stored transverse sensitivity;
and determining the concentration of SO₃ and/or H₂SO₄ from the corrected absorption values.

5. A method in accordance with claim 4, wherein other gas components can also be cyclically detected with the photometer and their concentrations can be determined.

6. A method in accordance with claim 4, wherein, for the alignment and/or drift monitoring, an optical alignment filter is used at certain time intervals which generates a constant known absorption at the measurement wavelength.
